(19) United States
(12) Patent Application Publication
(10) Pub. No.: US 2006/0210824 A1
(43) Pub. Date: Sep. 21, 2006

(54) Low friction electrical contacts

(76) Inventors: Charles R. Harrington, Troy, MI (US); George A. Drew, Warren, OH (US); Neil R. Aukland, Sterling Heights, MI (US)

Correspondence Address: DELPHI TECHNOLOGIES, INC., M/C 480-410-202, PO BOX 5052, TROY, MI, 48007, US

(21) Appl. No.: 11/101,199

(22) Filed: Apr. 7, 2005

Related U.S. Application Data
(60) Provisional application No. 60/661,706, filed on Mar. 15, 2005.

(51) Int. Cl. B32B 15/08; B32B 27/00

(52) U.S. Cl. 428/624; 428/626; 428/646; 428/647; 428/463

(57) ABSTRACT

Described is an electrical contact comprising a conductive surface of nickel, tin, or a precious metal having a surface of formed grains and particles of a low friction polymer deposited on a portion of the grains wherein the resistance of the contact is about 1 ohm or less, measured at about 100 mA, and wherein the polymer particles are deposited on the grains from a dispersion of the particles in a liquid.

### CROSS-REFERENCE TO RELATED APPLICATION

This application claims priority to U.S. Provisional Patent Application Ser. No. 60/661,706, entitled Polymeric Dispersions for Wear-Resistant, Low Resistance Electrical Interconnections, Inventors: Charles R. Harrington and George A. Drew, attorney docket number 2151.4164.001 (DP-313723) filed Mar. 15, 2005, which is hereby incorporated by reference.

### TECHNICAL FIELD

The present invention relates to electrical contact surfaces that provide corrosion and oxidation resistance and retain low contact electrical resistance in combination with reduced engage/disengage force and consequential wear requirements.

### BACKGROUND OF THE INVENTION

The electrical content of automobiles and other useful articles of manufacture is continually increasing, leading to a corresponding increase in the demand for reliable electrical interconnections. In the case of automobile connectors, many applications require multi-terminal male/female type connectors. Multi-terminal connectors require appreciable force to engage or disengage the connection and it is, of course, important that such connectors be fully and properly engaged.

The automobile industry likewise is in need of wear resistant low friction electrical terminals as well as wear resistant low power sliding switches.

Electrical terminals are generally made using copper alloys that provide beneficial physical and electrical properties. Copper alloy terminals or the originating strip, which would oxidize in the air, are typically electroplated with tin, silver or gold layer onto such copper alloy surfaces. These surface metals provide oxidation and wear protection to the copper alloy surface.

Low friction polymeric particles have been applied to such electroplated metals such as tin, silver, and gold. See U.S. Pat. No. 6,254,979.

It is desirable in an efficient manufacturing process to apply the low friction insulating polymeric particles in a quick and efficient manner.

### SUMMARY OF THE INVENTION

Described is an electrical contact comprising a conductive surface of nickel, tin, or precious metal having a surface of formed grains and particles of a low friction polymer deposited on a portion of the grains wherein the resistance of the contact is about 1 ohm or less, measured at about 100 mA, and wherein the polymer particles are deposited on the grains from a dispersion of the particles in a liquid having a flash point, at ambient pressure, of about 100 degrees Centigrade or less.

Another embodiment is an electrical contact comprising a conductive surface comprised of nickel, tin, or precious metal with a surface of formed grains and particles of a low friction electrically-insulating polymer deposited on a portion of the grains wherein the resistance of the contact is about 1 ohm or less, measured at about 100 mA, and wherein the polymer particles are deposited on the grains from a dispersion of the particles in an organic liquid wherein the liquid has a vapor pressure of at least about 1 mm Hg at 25° C.

Another embodiment of the invention is a method for making an electrical contact having low friction engagement between two conductive contact surfaces and low contact resistance between the surfaces, comprising, providing in the form of grains, nickel, tin, or precious metal on a surface of the contact and depositing particles of a low friction insulative polymer on a portion of the grains from a dispersion of the low friction particles in a liquid, wherein the resistance of the resulting contact is about 1 ohm or less, measured at about 100 mA, and wherein the polymer particles are deposited on the grains from a dispersion of the particles in a liquid having a flash point at ambient pressure of about 100 degrees Centigrade or less.

Another embodiment is a method of making an electrical contact having low friction engagement between two contact surfaces and low contact resistance between the surfaces, comprising, providing in the form of grains, nickel, tin or a precious metal on a surface of the contact and depositing particles of a low friction polymer on a portion of the grains from a dispersion of the low friction particles in a liquid, wherein the resistance of the resulting contact is about 1 ohm or less, measured at about 100 mA, and wherein the polymer particles are deposited on the grains from a dispersion of the particles in an organic liquid wherein the liquid has a vapor pressure of at least 1 mm Hg at 25° C.

### DETAILED DESCRIPTION OF THE INVENTION

The electrical contact that is utilized in the present application can be made of a variety of electrically conductive solid materials such as plastic with a copper alloy or other conductive material deposited onto a substrate. In order to increase the corrosion or oxidation resistance of such copper alloys, other electrically corrective metals may be deposited onto the copper such as nickel, tin, or a precious metal, such as gold, silver, palladium, or platinum and the like. Such materials can facilitate a reliable electrical contact in air and other oxidizing environments. These materials can be characterized as grainy in nature and may be initially applied to produce a matte surface texture. The application of such materials is well known to one of skill in the art. See the Metals Handbook, 9^{th} Edition, Volume 5 for the application of such well known processes for the coating of such metals.

In the application of the low friction particles, the end product can be characterized as particles of the polymeric material fitting in and around and on the metal grains. It is to be appreciated that the objective is to obtain polymeric particles that do not fully insulate the substrate so that it cannot function as an electrical contact. Therefore, it is typically desirable that the final electrical interconnection exhibits surface electrical resistance no greater than about 1 ohm (Ω) or less, measured at about 100 mA. In the application of the low friction insulating polymeric particles onto the metallic grains and into exposed crevices, it is desirable that the application be performed in an efficient and effective manner. In other words, the particles would be present in a suspension or dispersion of a liquid that may be removed promptly after the application of the suspension onto the substrate.

While a variety of low friction insulating polymeric particles may be utilized, such as polyimides and other fluorocarbons, such as telomers, a preferred particle is polytetrafluoroethylene (PTFE). These particles commercially vary in size from 0.1 to over 100 μm, but function preferably within the 0.1 to 3 μm range. The defining criteria is that the contact itself would not have so high a resistance that the contact cannot be used, from an electrical perspective, and appropriately carry an electrical current. Frequently such contact surfaces, whether they are male/female terminals or sliding switch contacts or any other electrical contact, have a resulting electrical resistance of 1 ohm or less, measured at about 100 mA, generally at 1 Newton of force.

The carrier for the particles in the suspension should be one where the material will be removed in a prompt and efficient manner after the application to the conductive surface. The beneficial liquid correspondingly can be one that has a flash point about 100 degrees Centigrade or less. Such materials are quite varied and may be made of a blend or mixture of materials, including azeotropic mixtures. Some suitable materials would be lower alkanols, glycols or glycol ethers, from 1 to 6 carbon atoms, lower ketones of from 3 to 6 carbon atoms or ethylene or propylene oxide derivatives of such alcohols or glycols or petroleum distillates (flash point 160° F.: 71° C.).

Other materials, suitable for the liquid carrier, may be an organic liquid for a suspending agent for the particles, such as, those that have a vapor pressure of 1 mm Mercury (Hg) or higher at 25° C. Such materials including fluorocarbons such as 2,3-dihydrodecafluropentane; polytetrafluoroethylene, omega-hydro-alpha (methyl cyclohexyl) (vapor pressure 226 mm Mercury at 25° C.); n-propyl bromide (vapor pressure of greater than 100 mm Mercury at 20° C.); ethylnonafluorobutyl or isobutyl ether (vapor pressure of 109 mm Mercury at 25° C.); pentane, 1,1,1,2,2,3,4,5,5,5-decafluro-3-methoxy-4 (trifluoromethyl)(41 mm Mercury at 68° F.); a halogenated fluorocarbon such as CF₃CHFCHFCF₂CF₃ (226 mm Mercury at 77° F.) and the like.

It is to be appreciated that the carrier may be likewise blended with water to control the flash point characteristics of the liquid carrier. The liquid carrier may be miscible or immiscible with water. The key criteria is that the liquid can act in a satisfactory manner to effectively disperse the particulate materials onto the electrically conductive substrate and then be removed, in an efficient manner for manufacturing purposes, leaving the deposit of the particles.

The amount of polymer particles can vary widely such as from about 0.1% to about 30% by weight of the total particle/liquid composition. It is also to be appreciated that the flash point and vapor pressure can be determined by any appropriate test known to those of skill in the art. The flash point and vapor pressure of the carrier can be determined on the carrier with or without the particles dispersed therein.

It is to be appreciated that a wide variety of application techniques can be utilized for depositing the polymeric particles onto the substrate. Such techniques include immersion, spraying, such as air sprays or airless sprays, and aerosols, roll coating, wiping, brushing, spinning (substrate rotates and liquid coating applied thereto) and the like. The liquid may be removed in any efficient manner from the substrate thereby leaving the particles deposited and dispersed onto the metallic substrate. Air-drying at ambient temperature is a technique. Other alternatives would be to utilize higher temperatures and/or lower pressures to increase the volatilization of the liquid.

Some suitable polymeric material dispersion products include DuPont Dry Film Ra Dispersions, DuPont Vydax 3622 Dispersions, DuPont Dry Film WDL5W Dispersions, DuPont LW 1200 dispersions plus isopropyl alcohol, and the like.

The components of the various liquid containing compositions may be used are as follows:

Components

| | | |
|---|---|---|
| Material | CAS Number | % by wt |

DryFilm Ra/IPA (Trademark of DuPont)

| Isopropyl Alcohol | 67-63-0 | 76-76 |
|---|---|---|
| | 65530-85-0 | |
| Poly-TFE, Omega-Hydro-Alpha-(Methylcyclohexyl)- | | 18-19 |
| Polytetrafluroethylene | 9002-84-0 | 6-7 |
| Flash Point: 12° C. | | |
| Vapor Pressure: 33 mm Hg @ | | |
| 20 C. (68 F.) | | |

DryFilm Ra (Trademark of DuPont)

| 2.3-Dihydrodecafluoropentane | 138495-42-8 | 84-86 |
|---|---|---|
| | 65530-85-0 | |
| Poly-TFE, Omega-Hydro-Alpha-(Methylcyclohexyl)- | | 11-12 |
| Polytetrafluroethylene | 9002-84-0 | 3-4 |
| Vapor Pressure: 226 mm Hg @ | | |
| 25 C. (77 F.) | | |

DryFilm LW-1200 (Trademark of DuPont)

| | | |
|---|---|---|
| Polytetrafluroethylene | 9002-84-0 | 20.0 |
| Alkyl Polyglycol Ether | 6843946-3 | 2.3 |
| Water | 7732-18-5 | 77.7 |
| Vapor Pressure: 24 mm Hg @ | | |
| 25 C. (77 F.) | | |

Miller-Stephenson MS-145W (Trademark of DuPont)

| | | |
|---|---|---|
| Telomer of Tetrafluroethylene | 9002-84-0 | 2.0 |
| Water | 7732-18-5 | 97.6 |
| Alkyl Polyglycol Ether | 68439-46-3 | 0.2 |
| Surfactants | | 0.2 |
| Vapor Pressure: 24 mm Hg @ | | |
| 77° F. | | |

DryFilm LXE/IPA (Trademark of DuPont)

| | | |
|---|---|---|
| Isopropyl Alcohol | 67-63-0 | 80-90 |
| Polytetrafluoroethylene | 9002-84-0 | 10-20 |
| Flash Point: 12° C. | | |
| Vapor Pressure: 33 mm Hg @ | | |
| 20 C. (68 F.) | | |

DryFilm 2000/IPA (Trademark of DuPont)

| | | |
|---|---|---|
| Isopropyl Alcohol | 67-63-0 | 80 |
| Polytetrafluoroethylene | 9002-84-0 | 20 |
| Flash Point: 12° C. | | |
| Vapor Pressure: 33 mm Hg @ | | |
| 20 C. (68 F.) | | |

DryFilm WDL-5W (Trademark of DuPont)

| | 65530-85-0 | |
|---|---|---|
| Poly-TFE, Omega-Hydro-Alpha-(Methylcyclohexyl)- | | |
| Polytetrafluoroethylene | 9002-84-0 | 1-2 |
| Isopropanol | 67-63-0 | 1.5-2.5 |
| Water | 7732-18-5 | 91-92 |
| Isopropanol Flash Point: 12° C. | | |
| Vapor Pressure: 24 mm Hg @ | | |
| 25 C. (77 F.) | | |

DryFilm WDL-10A (Trademark of DuPont)

| Isopropyl Alcohol | 67-63-0 | 88-91 |
|---|---|---|
| Poly-TFE, Omega-Hydro-Alpha-(Methylcyclohexyl)- | | 6-7 |
| Polytetrafluoroethylene | 9002-84-0 | 2-3 |
| NJ Trade Secret Registry # 00850201001-5632P | | 1-2 |
| Flash Point: 12° C. | | |
| Vapor Pressure: 33 mm Hg @ | | |
| 20 C. (68 F.) | | |

Vydax 3622 (Trademark of DuPont)

| | | |
|---|---|---|
| Polytetrafluoroethylene | 9002-84-0 | 2-4 |
| Proprietary Resin | | 1-3 |
| Propylene Glycol Monomethyl Ether | 107-98-2 | 9-11 |
| Isopropyl Alcohol | 67-63-0 | 74-77 |
| Petroleum Naphtha | 64742-48-9 | 5-6 |
| Diacetone Alcohol | 123-42-2 | 1-2 |
| Flash Point: 11° C. | | |

The testing procedures that were followed on Table 1 are as follows:

This section specifies the test procedures and equipment used to evaluate the bare and PTFE coated samples. The average standard sliding test data set for bare matte tin is presented to exemplify the analysis procedure, using the baseline condition.

Sample Preparation

Test samples were prepared so that the amount of residual PTFE mass on each sample could be estimated. Each PTFE product was sufficiently diluted to a PTFE mass concentration capable of producing a surface resistance less than 100 mΩ. Each candidate concentration was sampled (10 μl) and applied to the top surface of a tin sample and then heated to 85° C. for 10 minutes to evaporate the liquid. The density and mass fraction specified for each product concentrate was used to determine the PTFE mass dispensed. The area over which the PTFE particles spread was approximated to estimate the PTFE mass of per unit area on each area.

Test Equipment

Three instruments were used to characterize each bare or coated sample prepared. The standard sliding test was performed on 23 bare tin sample pairs toward determination of the baseline level of surface resistance, friction and wear. The performance of each PTFE product was determined using at least two pairs of matte tin production strip samples. One sample set was tested for electrical resistance, using the contact probe [17], as a function of normal force applied at 5 locations in the area of the dispersed PTFE. The resistance value at normal force of 1 N (100 g load) was interpolated from each data set for inter-comparison. The other sample set was stamped using a standard tool having a 3.2 mm diameter steel ball, to form a dimpled surface in the coated area. Each dimple and flat pair was then mounted separately to perform the sliding test.

The “dimple on flat” sliding test can discriminate between different materials and lubricants based on the frictional force generated during the simulation of 10 terminal connect/disconnect cycles. This standard sliding test consists of a mass (250 g) positioned on a dimpled sample, above the single contact point, that creates a wear track on the flat sample that moves back and forth beneath it. The frictional force generated is continuously measured with a calibrated sensor and periodically sampled by computer 250 times between the end points of each 2.5 mm long stroke (half-cycle).

Sliding Friction Analysis

The frictional force generated during each sliding stroke is averaged for all unlubricated sample pairs versus sliding cycle number. The normal load above the contact point was 2.5 N (250 g). The force generated by each bare sample after the first stroke increased from 1.2 N to 1.9 N after completion of the second cycle (4^{th} stroke) and then decreases gradually to 1.0 N after the 10^{th} cycle, possibly due to smoothing of the matte surface texture. The force data standard deviation increased to a peak value at 3.5 sliding cycles that was nearly a factor 5 greater than at the beginning or the end of the test. The total work value in Table 1 for the bare tin surfaces (64 mJ) was calculated as the product of the average frictional force measured overall cycles for all 23 sample pairs (1.27 N) and the total test distance (50 mm).

Listed in Table 1 below is the application of the various dispersions placed onto the electrodeposited substrates identifying the particle size, the liquid type, the density of the liquid product, the product mass, the product volume, alcohol volume fraction, and the test results identifying the particle density after removal by evaporation of the liquid, the surface electrical resistance, the sliding work force required and the wear depth.

TABLE 1
Basic PTFE dispersion parameters that are relevant to the particle density calculation used to distinguish between the test results, acquired
on electroplated tin having a matte surface finish. The particles were dispersed using either water or isopropyl alcohol (IPA).

| 1 ml- | | | | | | | | | | | Test Results | | | |
|---|---|---|---|---|---|---|---|---|---|---|---|---|---|---|
| 1 cm³ | Material Parameters | | | | | | Sample Preparation | | | | | | | Wear |
| Test | Particle | | Density | | Product | Product | Alcohol | PTFE | | | Particle | Surface | Sliding | Depth |
| Sample | Size | Liquid | Liquid | Particle | Mass | Volume | Volume | Concentration | Mass | Area | Density | Resistance | Work | Flat |
| Label | (μm) | Type | (g/cm³) | (g/cm³) | Fraction | (ml) | fraction | (g/l) | (μg) | (cm²) | (μg/cm²) | (mΩ) | (mJ) | (μm) |
| 0 | None | None | | | | | | | | | 0.0 | 2.2 | 63.6 | 0.71 |
| 1 | 2-3 | Vertrel | 1.58 | 1.63 | 0.15 | 1 | 0 | 15.3 | 153 | 0.6 | 246.2 | 92.5 | 3.3 | 0.010 |
| 2x | 2-3 | IPA | 0.7855 | 0.96 | 0.25 | 1 | 1 | 9.2 | 92 | 1.3 | 72.3 | 3.9 | 4.4 | 0.007 |
| 2y | | | | | | | | | 92 | 1.3 | 69.4 | 3.3 | 3.6 | 0.013 |
| 3b | 2-3 | Water | 1 | 1.09 | 0.20 | 0.15 | 0 | 2.2 | 22 | 0.3 | 68.2 | 8.3 | 8.8 | 0.326 |
| 3d | 2-3 | Water | 1 | 1.09 | 0.20 | 0.15 | 0.5 | 2.2 | 22 | 0.4 | 56.3 | 3.6 | 26.4 | 0.437 |
| 4a1 | 0.1 | Water | 1 | 1.13 | 0.20 | 0.25 | 0 | 2.2 | 22 | 0.2 | 110.4 | 39.5 | 2.8 | 0.056 |
| 4a2 | | | | | | 0.16 | | 2.2 | 22 | 0.1 | 196.3 | 26.6 | 3.8 | 0.101 |
| 4b1 | 0.1 | Water | 1 | 1.13 | 0.20 | 1 | 0 | 10.8 | 108 | 1.9 | 57.8 | 7.2 | 5.4 | 0.119 |
| 4b2 | | | | | | 0.8 | 0 | 10.8 | 108 | 2.0 | 53.2 | 25.6 | 3.0 | 0.012 |
| 4d | 0.1 | Water | 1 | 1.13 | 0.20 | 0.16 | 0.5 | 2.2 | 22 | 0.9 | 26.3 | 4.0 | 5.2 | 0.180 |
| 5x | 3-5 | IPA | 0.7855 | 0.86 | 0.1 | 1 | 1 | 7.8 | 78 | 1.1 | 69.9 | 37.0 | 12.7 | 0.363 |
| 5y | | | | | | | | | 78 | 1.2 | 66.8 | 658.7 | 9.9 | 0.346 |
| 6x | 0.1 | IPA | 0.7855 | 0.89 | 0.2 | 1 | 1 | 8.5 | 85 | 2.1 | 39.8 | 3.1 | 18.4 | 0.349 |
| 6y | | | | | | | | | 85 | 2.1 | 39.8 | 2.3 | 43.7 | 0.200 |
| 6a | 0.1 | IPA | 0.7855 | 0.89 | 0.2 | 3 | 0 | 35.6 | 356 | 1.011 | 352.0 | 0.027 | 8.4 | 0.4005 |
| 7ax | 0.1 | Water | 1 | 1.01 | 0.02 | 1.5 | 0 | 1.8 | 18 | 0.3 | 58.0 | 6.3 | 7.0 | 0.161 |
| 7ay | | | | | | | | | 18 | 0.3 | 58.0 | 6.4 | 5.2 | 0.266 |
| 7bx | 0.1 | Water | 1 | 1.01 | 0.02 | .0375 | 0 | 0.5 | 5 | 0.1 | 43.2 | 9.5 | 5.5 | 0.052 |
| 7by | | | | | | | | | 5 | 0.1 | 43.2 | 10.4 | 5.5 | 0.178 |

Product 7 is a product supplied by Miller-Stevenson Chemical Company and was prepared by diluting product 4 (DuPont-LW 1200) by a factor of 10 with water and adding 0.2% by weight of a surfactant. It should be noted that product 4 contains also 2.3% by weight alkyl polyglycol ether.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. An electrical contact comprising a conductive surface comprised of nickel, tin, or a precious metal having a surface of formed grains and particles of a low friction polymer deposited on a portion of the grains wherein the resistance of the contact is about 1 ohm or less, measured at about 100 mA, and wherein the polymer particles are deposited on the grains from a dispersion of the particles in a liquid having a flash point, at ambient pressure, of about 100 degrees Centigrade or less.

2. The contact of claim 1 wherein the liquid is compatible with the particles.

3. The contact of claim 1 wherein the liquid is comprised of a lower aliphatic alcohol or glycol.

4. The contact of claim 1 wherein the liquid is comprised of a lower aliphatic ketone.

5. The contact of claim 1 wherein the liquid is miscible with water.

6. The contact of claim 1 wherein the liquid is an azeotropic liquid.

7. The contact of claim 1 wherein the contact is comprised of a sliding switch.

8. The contact of claim 1 wherein the contact is a male/female connector terminal.

9. An electrical contact comprising a conductive surface comprised of nickel, tin, or a precious metal with a surface of formed grains and particles of a low friction electrically-insulating polymer deposited on a portion of the grains wherein the resistance of the contact is about 1 ohm or less, measured at about 100 mA, and wherein the polymer particles are deposited on the grains from a dispersion of the particles in an organic liquid wherein the liquid has a vapor pressure of at least about 1 mm Hg at 25° C.

10-18. (canceled)
